(19) United States
(12) Patent Application Publication
(10) Pub. No.: US 2003/0074334 A1
(43) Pub. Date: Apr. 17, 2003

(54) Sealed freight enclosure

(76) Inventors: Jeffrey Garfinkle, New York, NY (US); Pasquale Maglione, Little Neck, NY (US)

Correspondence Address: WALTER J, TENCZA JR., 10 STATION PLACE, SUITE 3, METUCHEN, NJ, 08840, US

(21) Appl. No.: 10/300,518

(22) Filed: Nov. 20, 2002

Related U.S. Application Data
(62) Division of application No. 09/568,113, filed on May 10, 2000.

(51) Int. Cl. G06F 17/00; B65D 41/02

(52) U.S. Cl. 705/500; 220/265

(57) ABSTRACT

A method is disclosed comprising locking a freight enclosure with a lock so that freight inside the freight enclosure can be accessed only by breaking the lock or by damaging the freight enclosure. The lock typically has a serial number which can be seen by an agent receiving the lock unless the lock has been defaced. The method may include transporting the freight enclosure, and thereafter checking the lock to make sure it is not broken, the serial number to make sure it is correct, and the freight enclosure to make sure it is not damaged. An entry may be made in a log book, noting the last entity to send the freight enclosure, if these conditions are not satisfied.

### CROSS REFERENCE TO RELATED APPLICATION

This application is a divisional of and claims the priority of patent application Ser. No. 09/568,113, filed on May 10, 2000, title “SEALED FREIGHT ENCLOSURE” inventors and applicants Jeffrey Garfinkle and Pasquale Maglione.

### FIELD OF THE INVENTION

This invention relates to improved methods and apparatus for packaging, transport, and delivery of freight.

### BACKGROUND OF THE INVENTION

In the air freight transportation industry, before an air freight pallet is received at its final destination, it must first go through several steps. The manufacturer's initial; transportation agent wraps the pallet in plastic, tape, and in some cases chicken wire, the pallet is then sent via truck to the airport where it may stay, exposed to the elements (often rain) as well as exposed to potential theft for up to 24 hours pending being put on board a plane. Upon the plane's landing, the pallet is taken off the plane, at which point it may again remain for up to 24 hours pending pick-up by truck. After the trucking company picks up the pallet, it is delivered to another warehouse where the pallet is broken down into its deliverable parts and readied for delivery to its final destination.

At each point in the pallet's journey, the receiving agent must sign for the freight and indicate, upon inspection, that the freight is intact—i.e. none of the goods are missing or damaged. The inspection, however, is almost never thorough. This is due to the fact that in order to reasonably conclude that the goods are intact, the receiving agent would have to remove the packaging material and examine every box. This is hardly practical as there are both time and manpower constraints, as well as the need for additional packaging upon the removal and therefore necessary disposal of this packaging.

Since this method of inspection is impractical and therefore not utilized, the freight is merely assumed to be intact. If however, a portion has been damaged or lost, it will not be realized until the agent that breaks down the freight has prepared it for final delivery. At this point, time, manpower and considerable money has been lost, as the freight must be remanufactured and be reshipped, and insurance claims are filed by all agents claiming the theft or damage was not their responsibility.

### SUMMARY OF THE INVENTION

The present invention in one embodiment includes an apparatus comprising a freight enclosure comprising a top portion and a bottom portion. The top portion is connected to the bottom portion by a connection device. The connection device is locked by a lock which prevents the top portion from being separated from the bottom portion. The lock has a code or serial number which uniquely identifies the freight enclosure.

The connection device may be comprised of a first set of zipper teeth located on the top portion which is linked to a second set of zipper teeth located on the bottom portion. The connection device may be further comprised of a first zipper which has a first loop which is connected to the lock and the lock prevents the first zipper from unlinking the first set of zipper teeth from the second set of zipper teeth. The connection device may be further comprised of a second zipper which has a second loop which is connected to the lock and the lock connects the first zipper with the second zipper and prevents the first and second zippers from unlinking the first set of zipper teeth from the second set of zipper teeth.

The lock may be a seal which can only be opened by breaking the lock, and after the lock is opened, the lock can not be locked again. The lock may be a metal seal.

The top portion of the freight enclosure may have a box structure comprised of first, second, third, and fourth sides and a top side which enclose a first area. The bottom portion may have a box structure comprised of a first, second, third, and fourth sides and a bottom side which enclose a second area. The second area enclosed by the bottom portion may be smaller than the first area enclosed by the top portion so the top portion can fit over the bottom portion. When the top portion is connected to the bottom portion, the top portion may at least partially overlap over the bottom portion.

The connection device may be comprised of a first part connected to the top portion, which may be a first set of zipper teeth and a second part connected to the bottom portion of the freight enclosure which may be a second set of zipper teeth. The first and second sets of teeth may be causes to connect by one or more zippers. The first part of the connection device is connected to the top portion so that it lies within the first enclosed area of the top portion.

A first sealing section, which may be VELCRO™, may be located on the top portion of the freight enclosure and a second sealing section, which may be VELCRO™, may be located on the bottom portion of the freight enclosure. The first and second sealing sections can be joined together to seal the freight enclosure.

In accordance with a method of an embodiment of the present invention, a method is disclosed comprising the steps of applying a serial number to a lock, wherein the lock is a seal which can only be opened by breaking the lock, using the lock to lock a freight enclosure, transporting the freight enclosure, and checking the lock after transport of the freight enclosure to see if the lock has been broken. If the lock has been broken, an indication may be placed in a log book that the lock has been broken and an indication may be placed in the log book of the entity who last sent the freight enclosure.

The freight enclosure and a method of use in accordance with an embodiment of the present invention are particularly useful in the air freight transportation industry. Water damage to freight is reduced, pilferage of freight is reduced, cost of insurance claims filed subsequent to either water damage or pilferage is reduced (both the labor cost of filing claims, as well as unrecoverable increases in premium costs), and the use of non-recyclable plastic currently used as packaging for freight pallets is reduced or eliminated. There is a high cost for the non-recyclable plastic.

The Freight enclosure serves as an ongoing insurance policy that prevents water damage, deters thieves, reduces claims, and eliminates the need for non-recyclable, and therefore environmentally dangerous, plastic wrapping. All of this leads to intact freight, reduced expenses, and satisfied clients.

### BRIEF DESCRIPTION OF THE DRAWINGS

FIG. 1 shows a perspective view of a freight enclosure in accordance with an embodiment of the present invention including a top portion and a bottom portion with the top portion and bottom portion separated; and

FIG. 2 shows a perspective view the freight enclosure of FIG. 1 with the top and bottom portions attached together.

### DETAILED DESCRIPTION OF THE DRAWINGS

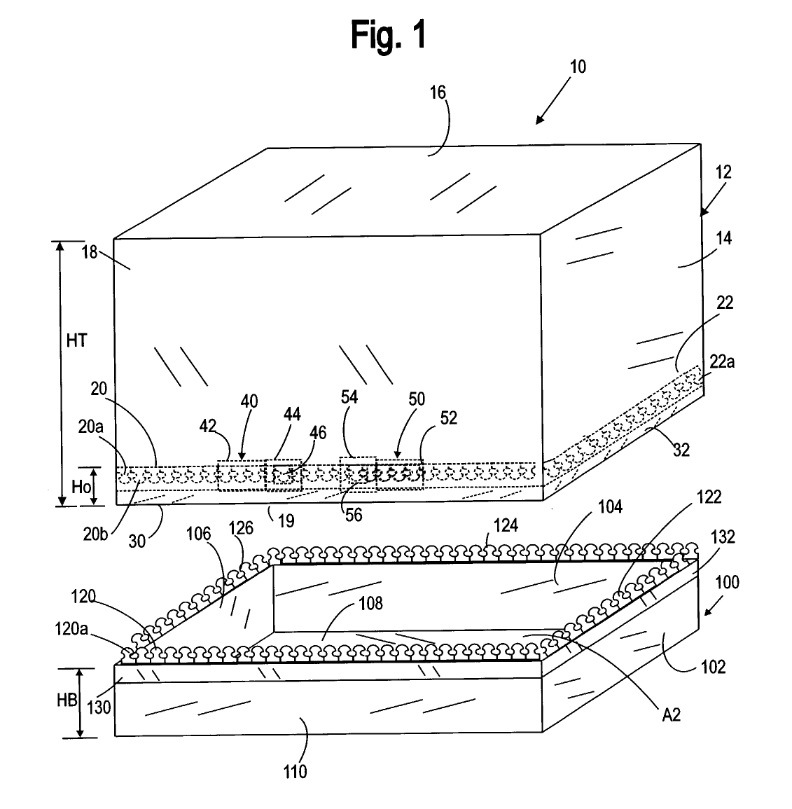

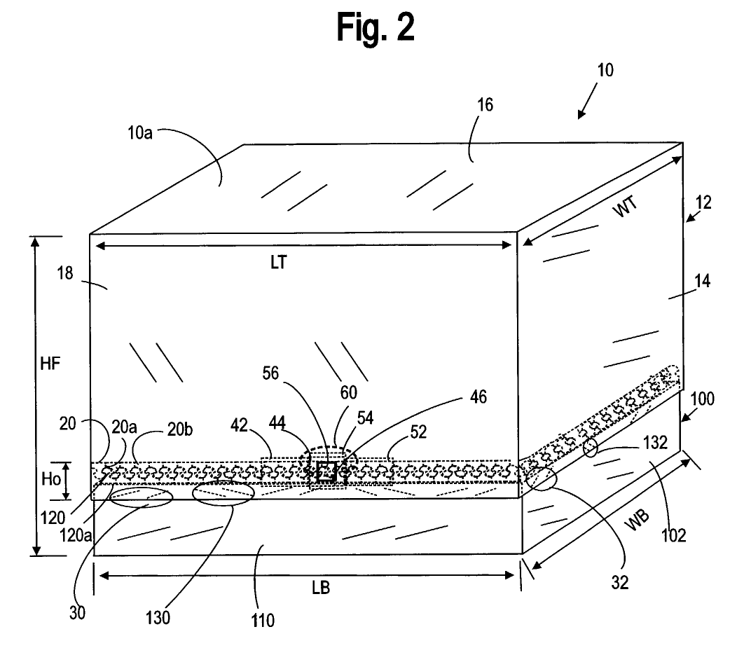

FIG. 1 shows a perspective view of a freight enclosure 10 in accordance with an embodiment of the present invention including a top portion 12 and a bottom portion 100 with the top portion 12 and the bottom portion 100 shown separated. FIG. 2 shows a perspective view the freight enclosure 10 of FIG. 1 with the top portion 12 and the bottom portion 100 attached together.

The top portion 12, as shown in FIG. 1, has a box structure. The top portion 12 is comprised of side 14 (and an opposite side not shown), side 18 (and an opposite side not shown), and top side 16. The side 14 (and its opposing side), side 18 (and its opposing side), and top side 16 form enclose a first area. The top portion 12 can be placed on top of freight, an object, or a package, so that the freight, object or package, lies inside the first area enclosed by the sides 14 and 18 (and their opposing sides) and the top side 16.

Side 18 of the top portion 12 is comprised of a VELCRO™ section 30 which may be comprised of hooks or loops of a VELCRO™ system. The VELCRO™ section 30 may be thought of as a section of a sealing device in accordance with the present invention. Similarly, side 14 of the top portion 12 is comprised of a VELCRO™ section 32 which may be comprised of hooks or loops of a VELCRO™ system. The VELCRO™ section 32 may be thought of as a section of a sealing device in accordance with the present invention. The VELCRO™ sections 30 and 32, in the embodiment shown in FIG. 1, lie inside the first area enclosed by the sides 14 and 18 (and their opposing sides) and top side 16. There can also be a VELCRO™ section on the side opposite to side 18 near the bottom of that side, similar to opposing VELCRO™ section 30, which also lies inside the box structure of top portion 12. There can also be a VELCRO™ section on the side opposite side 14 near the bottom of that side, similar to opposing VELCRO™ section 32, which also lies inside the box structure of top portion 12. The VELCRO™ sections 30 and 32 on the top portion 12 are shown in dashed lines to show that they are inside the box structure of top portion 12.

The top portion 12 is also comprised of a first set of zipper teeth comprised of portions 20 and 22. Portion 20 of the first set of zipper teeth has a plurality of zipper teeth (such as tooth 20a) which are attached to the side 18 of the top portion 12. The side opposing side 18 (not shown) also has a plurality of corresponding zipper teeth, not shown. Portion 22 of the first set of zipper teeth has a plurality of zipper teeth (such as tooth 22a) which are attached to the side 14 of the top portion 12. The side opposing side 14 (not shown) also has a plurality of corresponding zipper teeth, not shown. The zipper teeth of portions 20 and 22 and their opposing portions not shown, are seamlessly connected so that a zipper or zippers can move around the entire freight enclosure 10 along the first set of zipper teeth.

The top portion 12 may be made of a durable waterproof fabric material, such as TYVEK™, which was created by DUPONT. TYVEK is a lightweight durable fabric that can withstand the punishment of the elements of the weather and of heavy usage. The first set of zipper teeth, including teeth on the sides 14 and 18 and their opposing sides, can be sewn into the fabric material of top portion 12. The first set of zipper teeth can be sewn inside the first area enclosed by the sides 14 and 18 (and their opposing sides) and tip side 16. I.e. the first set of zipper teeth, in one embodiment, would not normally be able to be seen from the perspective shown by FIG. 1 (unless the TYVEK material of top portion 12 is transparent), and for that reason in FIG. 1, the plurality of teeth 20 and 22 are shown in dashed lines.

FIG. 1 also shows a first zipper 40 and a second zipper 50. The zippers 40 and 50 are connected to the teeth 20 and also lie inside the enclosed first area bounded by the sides 14 and 18 (and their opposing sides) and top side 16. For that reason the zippers 40 and 50 are shown in dashed lines also, because normally the zippers 40 and 50 could not be seen from the perspective shown by FIG. 1. Zippers 40 and 50 include attachment portions 42 and 52 which attach the respective zippers to the first set of zipper teeth, for example at portion 20. Zippers 40 and 50 may include loop portion 44 having an opening 46 and loop portion 54 having an opening 56, respectively.

The bottom portion 100 also has a box structure. The bottom portion 100 is comprised of sides 102, 104, 106, and 110, and bottom side 108. The sides 102, 104, 106, 110, and 108 bound an enclosed area A2 shown in FIG. 1. Side 110 of the bottom portion 100 is comprised of a VELCRO™ section 130 which may be comprised of hooks or loops of a VELCRO™ system. The VELCRO™ section 130 may be thought of as a section of a sealing device in accordance with the present invention. Similarly, side 102 of the bottom portion 100 is comprised of a VELCRO™ section 132 which may be comprised of hooks or loops of a VELCRO™ system. The VELCRO™ section 132 may be thought of as a section of a sealing device in accordance with the present invention. The VELCRO™ sections 130 and 132, in the embodiment shown in FIG. 1, lie outside the area A2. There can also be a VELCRO™ section on the side 104 near the top of the side 104, similar to opposing VELCRO™ section 120, which also lies outside the area A2. There can also be a VELCRO™ section on the side 106 near the top of the side 106, similar to opposing VELCRO™ section 132, which also lies outside the area A2.

The bottom portion 100 also includes a second set of teeth comprised of portions 120, 122, 124, and 126. The second set of teeth (portions 120, 122, 124, and 126 ) on bottom portion 100 is designed to mesh with the first set of teeth on the top portion 12 comprised of portion 20 and its opposing portion not shown, and portion 22 and its opposing portion not shown as shown by FIG. 2. The zippers 40 and 50 are used to connect the first set of teeth of top portion 12 with the second set of teeth of bottom portion 100 to thereby cause top portion 12 to be connected to bottom portion 100 as shown in FIG. 2.

The top portion 12 of the freight enclosure 10 has a height of HT which may be 59 inches. The bottom portion 100 has a height HB which may be 14 inches. When the top portion 12 and the bottom portion 100 are zipped together, as shown in FIG. 2, the top portion 12 overlaps the bottom portion 100 by a distance H0, which may be about three inches. The distance H0 corresponds to the approximate internal location of the first set of teeth on the top portion 12 which are located about three inches up from an edge, such as edge 19 for side 18 shown in FIG. 1. After the top portion 12 and bottom portion 100 have been zipped together the freight enclosure 10 has a final height of HF which may be seventy inches. The side 18 of top portion 12 may have a length LT which may be one hundred and thirty inches. The side 110 of the bottom portion 100 may have a length LB, shown in FIG. 2 which may be slightly less than the length LT of the top portion 12 to allow the top portion 12 to overlap the bottom portion 100. For example, LB may be one hundred and twenty-nine inches. A close fit should be provided.

The side 14 of the top portion 12 may have a width WT which may be 93 inches. The side 102 of the bottom portion 100 may have a width WB which may be slightly less than 93 inches, such as for example 92 inches, again to allow top portion 12 to overlap bottom portion 100.

In operation, an individual would place the freight or package onto bottom side 108 of the bottom portion 100. The freight enclosure 10 is particularly useful for enclosing freight loaded on a large pallet. The freight should be placed and should be of a size so that the top portion 12 can be placed on top of the freight and joined with the bottom portion 100 as shown in FIG. 2. The freight will lie in the combination enclosed area of the freight enclosure 10 which is bounded by top side 16, sides 14 and 18 (and their opposing sides) of top portion 12 and bottom side 108, sides 102, 104, 106, and 110 of the bottom portion 100.

The top portion 12 is placed over the freight and then zipped together to the bottom portion 100 by sliding the zippers 40 and 50 over the teeth 120, 122, 124, and 126 on the bottom portion 100 until all or virtually all of the first set of teeth on top portion 12 are linked to their appropriate partners on the second set of teeth on the bottom portion 100. For example, in FIG. 2, tooth 120a of the second set of teeth on bottom portion 100 is linked to teeth 20a and 20b of the first set of teeth on top portion 12. The first and second sets of teeth can be considered to be part of a connection device for connecting the top portion 12 and the bottom portion 100.

After all the first set of teeth and the second set of teeth are linked together, the zippers 40 and 50 are brought closely together so that the loops 44 and 54 overlap and opening 46 is on top of opening 56. At that point a ring or lock 60 may be placed through the openings 46 and 56 and used to join the zippers 40 and 50 so that the zippers 40 and 50 are connected together. The lock 60 may then be locked. The lock 60 may have a code or serial number attached or engraved on it which may be unique for this piece of freight, or pallet, or this particular freight enclosure 10.

Once the lock 60 has been sealed, a flap is used to cover the joined first set of zipper teeth (20, 22, and those teeth opposite 20 and 22 on top portion 12 ) and the second set of zipper teeth (120, 122, 124, and 126 ). The “flap” is a part of the top portion 12 which may include the section on side 18 having a height H0 from end 19 to the location where the teeth 20 are sewn (and may also include similarly located sections on side 14, and on opposing sides opposite of side 14 and 18 ). The “flap” part of top portion 12 may include a VELCRO™ portion which may include VELCRO™ portions 30 and 32 on sides 18 and 14 as well as VELCRO™ portions on opposing sides not shown. The VELCRO™ portions such as 30 and 32, may be located inside the box structure of the top portion 12 (i.e. bound by the sides 14 and 18 and their opposing sides and side 16). The purpose of this flap and additional VELCRO seal is to insure that no water may penetrate the joined first set of zipper teeth (20, 22, and opposing teeth) and the second set of zipper teeth (120, 122, 124, and 126). THE VELCRO sections 30 and 32 (and opposing portions join with VELCRO sections 130, 132, and opposing portions respectively on the bottom portion 100 as shown by FIGS. 1 and 2.

Following locking of the lock 60, and the sealing of the VELCRO flap the freight enclosure 10 is ready for transport.

The lock 60 can be a metal seal of a type that once it has been opened it can not be relocked. In this manner, a person receiving the freight enclosure can tell whether the lock 60 and therefore the freight enclosure 10 contents have been tampered with or the contents removed.

The immediately previous sending agent, therefore, can be absolved of liability for any missing or damaged freight discovered at a later time. As each receiving agent is asked to sign for the freight, he need only to check that the lock 60 is intact, that the freight enclosure 10 has does not have any rips, and that the serial number is correct. If so, that he can sign with assurances. If the lock is broken, the pallet has possibly been tampered with, and a signature is not made until an inspection is concluded, with any missing or damaged freight attributable to the previous agent. Additionally, if there are any rips in the material, the agent may assume potential damage or theft has occurred. As this is not plastic wrapping, which is easily ripped or sliced open, tears may not be concealed by mere tape, as is common with plastic wrapping. If a pilferer attempts to slice open the Glove and cover it up with tape, the next agent will see the tape as a warning that there has been tampering. This serves as an extremely effective deterrent to would-be thieves.

In accordance with a method of an embodiment of the present invention, at each stage of transport of a freight enclosure 10, an agent can check to see if the metal seal 60 or lock 60 has been tampered with. If it has not been tampered with, the agent can note this fact in a log sheet. Thus, it is possible to know during exactly what stage of transport tampering occurred. An agent receiving the enclosure 10 need only to check that the lock 60 is in tact and that the serial number is correct.

The waterproof aspect of an embodiment of the present invention eliminates water damage to the freight inside the enclosure 10 when the freight enclosure 10 is exposed to rain, snow or other liquid accumulation. This assumes there are no lacerations to the freight enclosure 10. The enclosure 10 may be comprised of Tyvek (for all the sides of both the top portion 12 and the bottom portion 100), which is a strong fabric used in the manufacturing of backpacks, tents and tarps. The United States military currently uses Tyvek for these and other purposes.

Using a durable material such as Tyvek also makes the enclosure 10 reusable. The reusable aspect eliminates the cost, labor, and environmental hazard associated with non-recyclable plastic packaging which previously was used for air freight. With regards to labor, the Glove takes less than one minute to ready for shipment. The below table shows examples of the high cost of use of recyclable plastic packaging for an estimated cost of $3 and 50,000 pallets per month and an estimated cost of $5 and 60,000 pallets per month.

### Annual Plastic Use and Cost on Pallets Travelling through Al Italia

| Plastic | | | | | |
|---|---|---|---|---|---|
| per Pallet | | Pallets/ | 2. Cost/ | 3. Cost/ | Plastic/ |
| (lbs.) | 1. Cost* | Month | Month | Year | Year** |
| 3 | $3 | 50,000 | $150,000 | $1,800,000 | 1,800,000 lbs. |
| 3 | $5 | 60,000 | $300,000 | $3,600,000 | 2,160,000 lbs. |

*Includes labor cost, as well as those costs associated with the filing of claims and high insurance premiums.
**Nonrecyclable

These costs are devastating from a business perspective because they are unrecoverable. The plastic is used once and once only. A reusable packaging serves as an investment, the cost of which may be spread over many uses. This will lead to a lower cost per use than that of disposable plastic.

Investment in a protective, durable, reusable, environmentally friendly packaging is desirable in order to grow profit margins as well as to aid in the preservation of our environment.

I claim:

1. A method comprising the steps of:
locking a freight enclosure with a lock so that freight inside the freight enclosure can be accessed only by breaking the lock or by damaging the freight enclosure.

2. The method of claim 1 wherein
the lock has a serial number which can be seen by an agent receiving the lock unless the lock has been defaced.

3. The method of claim 1 further comprising
transporting the freight enclosure.

4. The method of claim 3 further comprising
checking the lock after the step of transporting the freight enclosure to see if the lock has been broken.

5. The method of claim 2 further comprising
checking to see if the serial number of the lock is correct.

6. The method of claim 4 further comprising
placing an indication in a log book that the lock has been broken if the lock has been broken.

7. The method of claim 6 further comprising
placing an indication in the log book, wherein the indication specifies an entity who last sent the freight enclosure.

8. The method of claim 1 wherein
the freight enclosure is comprised of a durable material.

9. A method comprising
receiving a freight enclosure in which is located freight;
wherein the freight enclosure is locked by a lock having a serial number; and
wherein the freight within the freight enclosure can only be accessed by either breaking the lock or damaging the freight enclosure.

10. The method of claim 9 further comprising
checking the serial number of the lock.

11. The method of claim 9 further comprising
checking the freight enclosure to see if the freight enclosure is damaged.

12. The method of claim 9 further comprising
checking to see if the lock is broken.

13. The method of claim 12 further comprising
placing an indication in a log book if the lock is broken.

14. The method of claim 13 wherein
the indication placed in the log book specifies an entity which last sent the freight enclosure.

15. The method of claim 10 further comprising
checking the freight enclosure to see if the freight enclosure is damaged; and
checking to see if the lock is broken; and
signing for the freight enclosure if the lock is not broken, the freight enclosure is not damaged, and the serial number of the lock is correct.
